(19) United States
(12) Patent Application Publication
(10) Pub. No.: US 2023/0241789 A1
(43) Pub. Date: Aug. 3, 2023

(54) Bow Drill Knife With Bearing

(71) Applicant: Justin Byrd, Danielsville, GA (US)

(72) Inventor: Justin Byrd, Danielsville, GA (US)

(21) Appl. No.: 17/590,380

(22) Filed: Feb. 1, 2022

(51) Int. Cl. B26B 11/00

(52) U.S. Cl. CPC B26B 11/00

(57) ABSTRACT

The disclosure is the only product of its kind that has the capability of eliminating all of the friction during a bow drill set-up when attempting to start a fire and offers a multi-purpose tool that can be used to benefit all individuals during various occasions. This avant-garde product is uniquely designed with a sharp twenty Skandi grind knife, single bevel, and a bore that is easily accessible from either side of the handle. Moreover, the Byrd fire starter is crafted with durable materials to ensure long term sustainability and can be easily transported and stored in any casing and/or bag during expeditions.

### BACKGROUND

Traditional fire starting methods when exploring recreational activities outdoors can be time-consuming, tedious, and incredibly inconvenient, especially for a novice. The alternative option of starting a fire with a bow drill warrants the use of various equipment which can quickly further complicate the task let alone become tiring and heavy to carry all of required items in a bag while traversing the outdoors. There have been no products available as original equipment or as an aftermarket to address this problem.

An apparatus to simplify the process of starting a fire with a bow drill without the need of hauling various and heavy equipment is needed. There have been no products available as original equipment or as an aftermarket to address this problem either.

### SUMMARY OF THE INVENTION

The main purpose of the bow drill knife with bearing is to provide users with a knife bearing that enables individuals to quickly and conveniently start a fire via a bow drill set-up while camping, hunting, and/or fishing.

### BRIEF DESCRIPTION OF THE DRAWINGS

FIG. 1 is a left side elevational view of the bow drill knife with bearing in accordance with an embodiment of the present disclosure.

FIG. 2 is a top elevational view of the bow drill knife bearing's sleeve in accordance with an embodiment of the present disclosure.

FIG. 3 is a webbed cross section Z of the bearing in the handle according to an embodiment of the present disclosure.

FIG. 4 is a through hole cross section Z of the bearing in the handle according to an embodiment of the present disclosure.

Throughout the description, similar reference numbers may be used to identify similar elements depicted in multiple embodiments. Although specific embodiments of the invention have been described and illustrated, the invention is not to be limited to the specific forms or arrangements of parts so described and illustrated. The scope of the invention is to be defined by the claims appended hereto and their equivalents.

### DETAILED DESCRIPTION

Reference will now be made to exemplary embodiments illustrated in the drawings and specific language will be used herein to describe the same. It will nevertheless be understood that no limitation of the scope of the disclosure is thereby intended. Alterations and further modifications of the inventive features illustrated herein and additional applications of the principles of the inventions as illustrated herein, which would occur to one skilled in the relevant art and having possession of this disclosure, are to be considered within the scope of the invention.

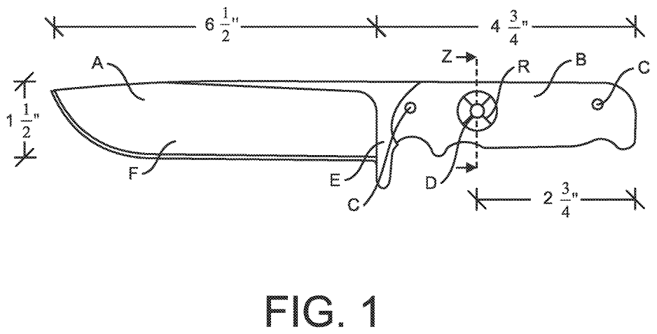

FIG. 1 is a left side elevational view of the bow drill knife with bearing showing: Knife 20 Skandi grind (single bevel) referenced as A, handle made of G-10 red & black referenced as B, thick aluminum 13/64″ pins referenced as C; ¼″ bore accessible from either side of the handle (spot welded to the tang) referenced as D, bevel (¼″ from top of blade spine) referenced as E, flat grind referenced as F, in accordance with an embodiment of the present disclosure. Radial lines R are implemented as radial ridges or radial groves to engage a fire stick in the chamfered bore. The bore is also implemented with a web on the inner ring of the bearing which is webbed or through hole in embodiments of the disclosure. The cross section Z is taken through the bearing B and the chamfered bore D.

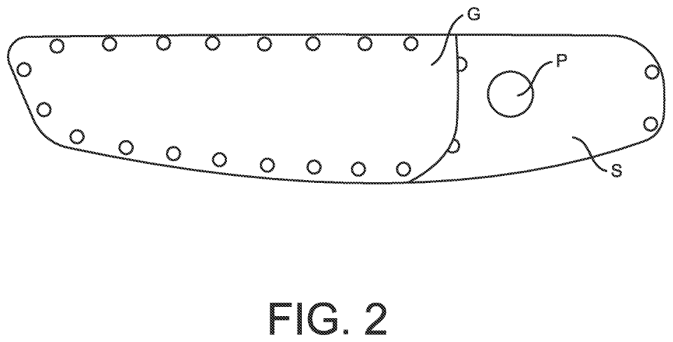

FIG. 2 is a top elevational view of the bow drill knife with bearing's sleeve in accordance with an embodiment of the present disclosure. The sleeve, also known as a sheath G encases the knife A and provides a substrate S for the handle which defines an opening P to expose the bearing even while the sleeve receives the knife.

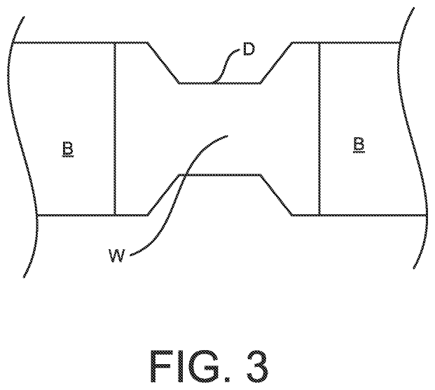

FIG. 3 is a webbed cross section Z of the bearing in the handle according to an embodiment of the present disclosure. The chamfered bore D comprises the webbing W configured to receive a fire stick (not depicted). The handle B supports the bearing and the chamfered bore D.

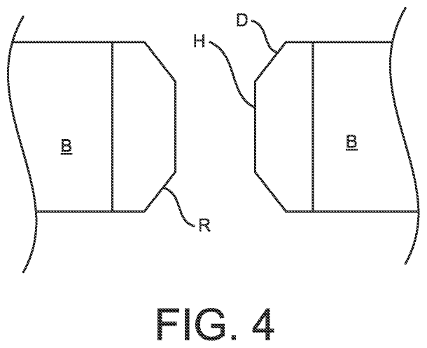

FIG. 4 is a through hole cross section Z of the bearing in the handle according to an embodiment of the present disclosure. The chamfered bore D defines a through hole H in the bearing supported by the handle B. Radial ridges R give frictional grip to a tip of a fire stick in the chamfered bore. Alternatively, radial groves provide a frictional grip on the fire stick.

The present disclosed bow drill knife with bearing, also known as the “Byrd Fire Starter” offers a modern accessory that requires less equipment and therefore enables individuals to start a fire in a more efficient manner. The Byrd fire starter introduces a novel multi-purpose bearing that not only saves space in any bag or carry-on but also offers a faster means to start a fire with a bow drill set-up in the woods, the knife handle of this bearing serves as a sturdy socket holder, helping to reaffirm placement and the bearing is strategically placed into the handle, to ensure users will no longer have to use a piece of wood or rock to ignite a fire. The Byrd fire starter ensures a fully operational fire starting accessory that solves the friction problem that is associated with a bow drill set-up and significantly reduces the number of equipment needed to start a fire.

Although the operations of the method(s) herein are shown and described in a particular order, the order of the operations of each method may be altered so that certain operations may be performed in an inverse order or so that certain operations may be performed, at least in part, concurrently with other operations. In another embodiment, instructions or sub-operations of distinct operations may be implemented in an intermittent and/or alternating manner.

What is claimed is:

1. A knife comprising:
a. a handle for a knife, wherein the handle comprises a first side and a second side; and
b. a bearing comprising a chamfered bore defined concentrically with the bearing and accessible from either the first or the second side of the handle to receive an end of a fire stick.

2. The knife of claim 1, further comprising a sheath for the knife wherein the sheath provides a substrate for the handle.

3. The knife of claim 1, further comprising a sheath for the knife wherein the sheath defines an opening configured to expose the bearing through a side of the sheath.

4. The knife of claim 1, wherein the handle further comprises a plurality of pins configured to extend through the handle and a shank of the knife.

5. The knife of claim 1, further comprising an opening in a sheath corresponding to the chamfered bore in the handle.

6. The knife of claim 1, wherein the chamfered bore defines a concentric hole through the bearing.

7. The knife of claim 1, wherein the chamfered bore defines a chamfer on an inner ring of the bearing.

8. The knife of claim 1, wherein the chamfered bore defines a chamfer of both sides of a wall extending across an inner ring of the bearing.

9. The knife of claim 1, wherein the chamfered bore is configured to receive a point of the fire stick.

10. The knife of claim 1, wherein the chamfered bore defines a divot configured to receive a point of the fire stick.

11. The knife of claim 1, wherein the chamfered bore defines radial grooves configured to engage with a point of the fire stick.

12. The knife of claim 1, wherein the bearing further comprises a chamfered inner ring having radial ridges defined thereon to engage the fire stick.

13. The knife of claim 1, wherein the bearing is spot welded stationary to a shank of the handle.

14. The knife of claim 1, wherein an outer ring of the bearing is spot welded to a tang of the handle and an inner ring of the bearing is free to rotatingly receive the fire stick.

15. The knife of claim 1, wherein the bearing is received through a width of the handle in a midsection of the handle.

16. The knife of claim 1, wherein the bearing further comprises a webbing on the chamfered bore configured to receive the fire stick.
